(19) United States
(12) Patent Application Publication
(10) Pub. No.: US 2023/0171272 A1
(43) Pub. Date: Jun. 1, 2023

(54) SYSTEM AND METHOD FOR DETECTING SIP NONCODING

(71) Applicant: Korea Internet & Security Agency, Naju-si (KR)

(72) Inventors: Do Won KIM, Naju-si (KR); Seong Min PARK, Naju-si (KR); Hyung Jin CHO, Naju-si (KR); Young Kwon PARK, Naju-si (KR); Dae Un KIM, Naju-si (KR); Sung Moon KWON, Naju-si (KR)

(73) Assignee: Korea Internet & Security Agency, Naju-si (KR)

(21) Appl. No.: 17/849,740

(22) Filed: Jun. 27, 2022

(30) Foreign Application Priority Data
Nov. 26, 2021 (KR) 10-2021-0165431

(51) Int. Cl. H04L 9/40; H04L 65/1045

(52) U.S. Cl. CPC H04L 63/1416; H04L 65/1045; H04L 63/083

(57) ABSTRACT

Disclosed are a system and a method for detecting session initiation protocol (SIP) noncoding, and more particularly, to a system and a method for detecting SIP noncoding, which can manage reputation of a client terminal according to whether or not the client terminal sends an encoded SIP message through a 5G non-standalone/Standalone (5G NSA/SA), thereby preventing an SIP spoofing attack.

### BACKGROUND OF THE INVENTION

### Field of the Invention

The present invention relates to a system and a method for detecting session initiation protocol (SIP) noncoding, and more particularly, to a system and a method for detecting SIP noncoding, which can manage reputation of a client terminal according to whether or not the client terminal sends an encoded SIP message through a 5G non-standalone/Standalone (5G NSA/SA), thereby preventing an SIP spoofing attack.

### Background Art

In general, in a 5G mobile network, all IP-based seamless services, such as voice services, text services, video call services, multimedia contents, and the likes, are provided through an IP multimedia subsystem (IMS) network using a session initiation protocol (SIP).

In this instance, in order to provide IP-based voice and various multimedia services in various wired/wireless networks and mobile terminals, the IMS has a call session control function (CSCF) and an application server (AS), and uses the SIP protocol which is a text-based signaling protocol in order to control the session between the CSCF and the AS.

The session initiation protocol (SIP) is a text-based protocol which establishes, modifies and terminates a multimedia session between a user and an agent based on RFC3329, and is composed of a REQUEST (SIP request message) and a RESPONSE (SIP response message).

In this instance, the REQUEST uses a REGISTER for registration and an INVITE for call setup as a representative method. The RESPONSE is defined as state codes ranging from lxx to 6xx, and has different purposes defined according to each of the state codes.

Such an SIP message is text-based, and is divided into a header part and a body part. In the header part, an SIP header having the method, a call-ID which is a unique ID of a session, and incoming and outgoing information is defined. In the body part, media information of the session is defined. In this instance, in the case of a voice or video call, a media codec is defined using a session description protocol (SDP).

Especially, since the SIP is text-based, it is easy to define and recognize the header, but has a disadvantage in that it is easy to forge or falsify. Due to such characteristics of the SIP message, conventionally, there are spoofing attacks using the SIP message.

For instance, as illustrated in FIG. 1, the spoofing attack is carried out in such a way as to transmit an SIP Deregi packet to an attack target, release the IMS connection of the attack target, and give a call to the attack target using a phone number of the attack target. Therefore, a system for preventing the spoofing attack is required.

### PATENT LITERATURE

### Patent Documents

Korean Patent No. 10-1396767, granted on May 12, 2014, entitled ‘System for providing SIP-based communication services and method thereof’

Korean Patent No. 10-1666594, granted on Oct. 10, 2016, entitled ‘SIP service system and control method thereof’

### SUMMARY OF THE INVENTION

Accordingly, the present invention has been made in view of the above-mentioned problems occurring in the prior art, and it is an object of the present invention to provide a system and a method for detecting session initiation protocol (SIP) noncoding, which can manage reputation of a client terminal according to whether or not the client terminal sends an encoded SIP message through a 5G non-standalone/Standalone (5G NSA/SA) so as to prevent an SIP spoofing attack.

To accomplish the above object, according to the present invention, there is provided a method for detecting session initiation protocol (SIP) noncoding through a session initiation protocol (SIP) noncoding detection system including the steps of: requesting a call connection with a receiving terminal to a session initiation protocol (SIP) server using a session initiation protocol (SIP) in a SIP client terminal; and receiving an SIP packet from the SIP client terminal and the SIP server and generating reputation by terminal in an intrusion prevention system for 5G mobile communication.

According to a preferred embodiment of the present invention, the step of receiving the SIP packet from the SIP client terminal and the SIP server and generating reputation by terminal in the intrusion prevention system for 5G mobile communication includes the steps of: determining whether or not the SIP packet is an SIP REGISTER by a control unit; determining whether or not the SIP packet is an authentication response according to a 401 unauthenticated code if the SIP packet is not the SIP REGISTER; and determining whether or not encryption of the SIP packet is applied if the SIP packet is an authentication response according to a 401 unauthenticated code, and updating reputation information by terminal of a terminal reputation DB.

According to a preferred embodiment of the present invention, in the step of determining whether or not the SIP packet is an SIP REGISTER, if the SIP packet is an SIP REGISTER, the control unit extracts a terminal model name and a VoLTE version from a user-agent field of the SIP packet, determines whether or not encryption is applied, and updates the reputation information by terminal of the terminal reputation DB.

According to a preferred embodiment of the present invention, in the step of determining whether or not the SIP packet is an authentication response according to a 401 unauthenticated code, if the SIP packet is not an authentication response, the control unit terminates an SIP packet inspection.

In another aspect of the present invention, there is provided a system for detecting session initiation protocol (SIP) noncoding including: a session initiation protocol (SIP) client terminal for requesting a call connection with a receiving terminal to a session initiation protocol (SIP) server using a session initiation protocol (SIP); and an intrusion prevention system for 5G mobile communication which receives a session initiation protocol (SIP) packet from the SIP client terminal and the SIP server and manages reputation by terminal.

According to a preferred embodiment of the present invention, the intrusion prevention system for 5G mobile communication includes: a terminal reputation DB storing reputation information by terminal; and a control unit receiving a session initiation protocol (SIP) packet from the SIP server and storing the reputation information by terminal to the terminal reputation DB.

According to a preferred embodiment of the present invention, the control unit carries out the steps of: determining whether or not the SIP packet is an SIP REGISTER; determining whether or not the SIP packet is an authentication response according to a 401 unauthenticated code if the SIP packet is not the SIP REGISTER; and determining whether or not encryption of the SIP packet is applied if the SIP packet is an authentication response according to a 401 unauthenticated code, and updating reputation information by terminal of a terminal reputation DB.

According to a preferred embodiment of the present invention, in the step of determining whether or not the SIP packet is an SIP REGISTER, if the SIP packet is an SIP REGISTER, the control unit extracts a terminal model name and a VoLTE version from a user-agent field of the SIP packet, determines whether or not encryption is applied, and updates the reputation information by terminal of the terminal reputation DB.

According to a preferred embodiment of the present invention, in the step of determining whether or not the SIP packet is an authentication response according to a 401 unauthenticated code, if the SIP packet is not an authentication response, the control unit terminates an SIP packet inspection.

As described above, the system and the method for detecting session initiation protocol (SIP) noncoding according to a preferred embodiment of the present invention can manage reputation of a client terminal according to whether or not the client terminal sends an encoded SIP message through a 5G non-standalone/Standalone (5G NSA/SA) and periodically the reputation to the client terminal, thereby preventing an SIP spoofing attack.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view illustrating a SIP spoofing attack using SIP Deregi;

FIG. 2 is a view illustrating a session initiation protocol (SIP) procedure according to RFC 3329;

FIG. 3 is a block diagram of a session initiation protocol (SIP) noncoding detection system according to an embodiment of the present invention;

FIG. 4 is a block diagram of an intrusion prevention system for 5G mobile communication according to an embodiment of the present invention;

FIG. 5 is a flow chart illustrating a session initiation protocol (SIP) noncoding detection method through the SIP noncoding detection system according to an embodiment of the present invention;

FIG. 6 is a flow chart illustrating the SIP noncoding detection method of the intrusion prevention system for 5G mobile communication according to an embodiment of the present invention; and

FIG. 7 is a view illustrating an SIP packet used for terminal reputation according to an embodiment of the present invention.

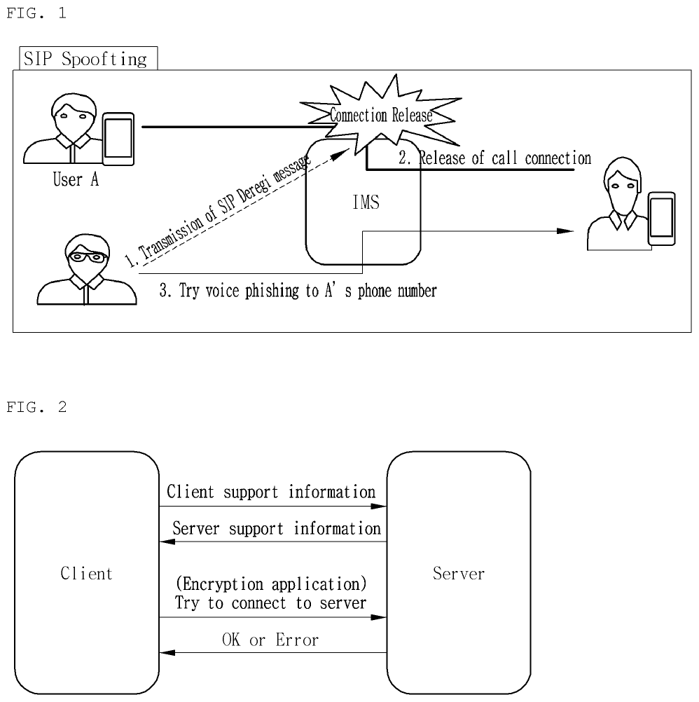

### DETAILED DESCRIPTION OF THE PREFERRED EMBODIMENT

Hereinafter, preferred embodiments of the present invention will be described in detail with reference to the accompanying drawings. Advantages and features of the present invention, and method to achieve them of the present invention will be obvious with reference to embodiments along with the accompanying drawings which are described below. Meanwhile, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims. In the detailed description, the same reference numbers of the drawings refer to the same or equivalent parts of the present invention.

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein. Terms used in the specification are provided for description of the exemplary embodiments, and the present invention is not limited thereto. In the specification, singulars in sentences include plural unless otherwise noted. Hereinafter, several preferred embodiments of the present disclosure will be described in detail with reference to the accompanying drawings.

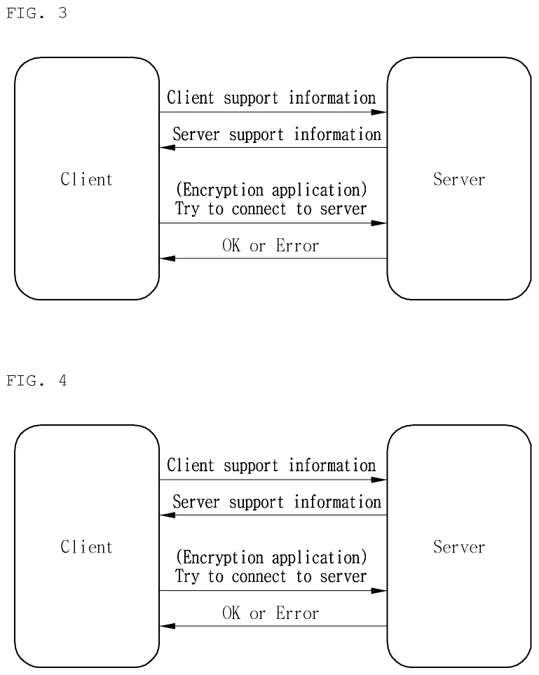

First, an SIP will be described. FIG. 2 is a view of a session initiation protocol (SIP) procedure according to RFC 3329. As illustrated in FIG. 2, when a session initiation protocol (SIP) according to RFC 3329 transmits security mechanism, which is supported by a client terminal and is included in the initial request, to a session initiation protocol (SIP) server, the SIP server requests for the client terminal to carry out a security agreement procedure, and transmits security mechanism and parameters supported by the server to the client terminal. Next, the client terminal responds to the SIP server using the security algorithm with the highest preference. Finally, the server transmits an OK message to the client terminal if there is nothing wrong.

The present invention relates to a system and a method for detecting an abnormal terminal with respect to whether encryption is used by collecting and analyzing session initiation protocol (SIP) messages of terminals using the session initiation protocol (SIP) and generating and managing reputation with respect to whether the corresponding terminals use encryption.

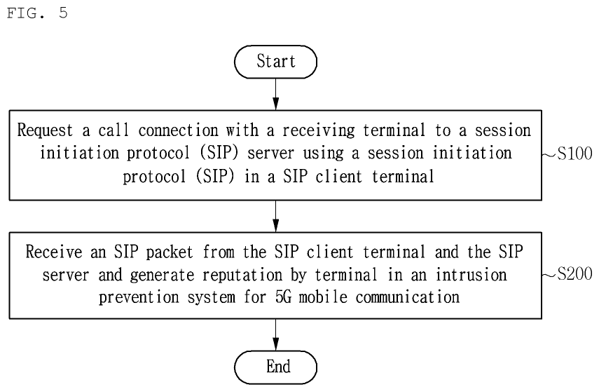

Hereinafter, referring to FIGS. 3 to 7, the system and the method for detecting session initiation protocol (SIP) noncoding will be described in detail.

FIG. 3 is a block diagram of a session initiation protocol (SIP) noncoding detection system according to an embodiment of the present invention, and FIG. 4 is a block diagram of an intrusion prevention system for 5G mobile communication according to an embodiment of the present invention. As illustrated in FIGS. 3 and 4, the SIP noncoding detection system according to an embodiment of the present invention includes: a session initiation protocol (SIP) client terminal 100 for requesting a call connection with a receiving terminal 300 to a session initiation protocol (SIP) server 200 using a session initiation protocol (SIP); and an intrusion prevention system for 5G mobile communication 400 which receives an SIP packet from the SIP client terminal 100 and the SIP server 200 and manages reputation by terminal.

Moreover, the intrusion prevention system 400 for 5G mobile communication includes: a terminal reputation DB 410 storing reputation information by terminal; and a control unit 420 receiving a session initiation protocol (SIP) packet from the SIP server 200 and storing the reputation information by terminal to the terminal reputation DB 410.

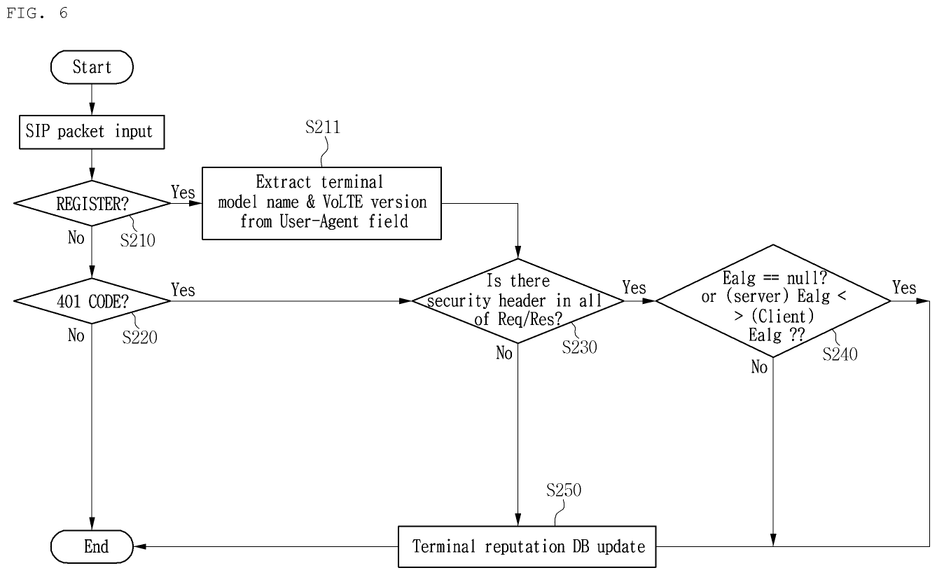

Hereinafter, referring to FIGS. 5 to 7, a session initiation protocol (SIP) noncoding detection method through the SIP noncoding detection system according to an embodiment of the present invention having the above configuration will be described in detail.

FIG. 5 is a flow chart illustrating a session initiation protocol (SIP) noncoding detection method through the SIP noncoding detection system according to an embodiment of the present invention. As illustrated in FIG. 5, the SIP noncoding detection method through the SIP noncoding detection system according to the embodiment of the present invention includes the steps of: (S100) requesting a call connection with the receiving terminal 300 to the SIP server 200 using the session initiation protocol (SIP) in the SIP client terminal 100; and (S200) receiving an SIP packet from the SIP client terminal 100 and the SIP server 200 and generating reputation by terminal in the intrusion prevention system 400 for 5G mobile communication.

In the step S100, the SIP packet transmitted to the SIP server 200 by the SIP client terminal 100 using the session initiation protocol is shown in FIG. 7. FIG. 7 is a view illustrating an SIP packet used for terminal reputation according to an embodiment of the present invention. As illustrated in FIG. 7, the terminal information and encryption of the client terminal can be checked in the SIP packet.

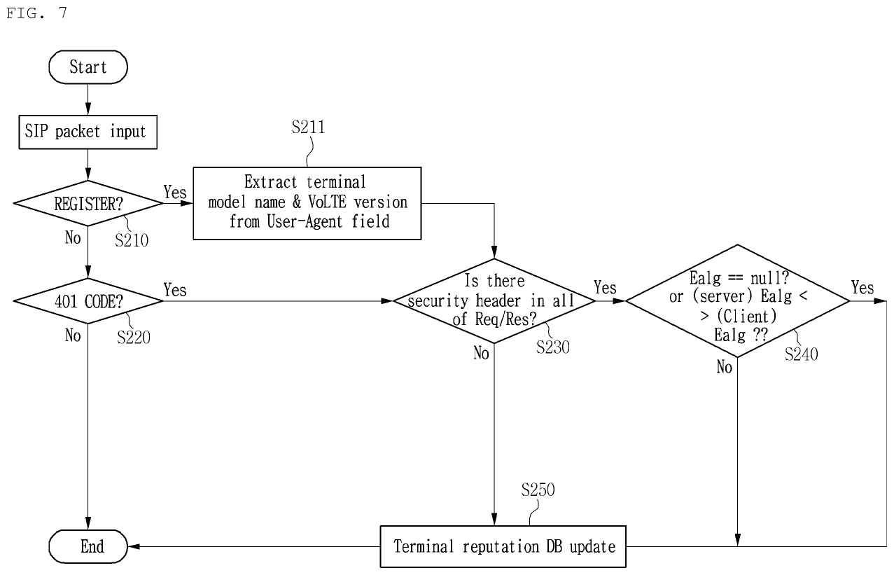

Referring to FIG. 6, the step S200 will be described in more detail. FIG. 6 is a flow chart illustrating the SIP noncoding detection method of the intrusion prevention system for 5G mobile communication according to an embodiment of the present invention. As illustrated in FIG. 6, the control unit 420 of the intrusion prevention system 400 for 5G mobile communication carries out a step S210 of determining whether the SIP packet is a SIP REGISTER or not.

In this instance, in the step S210, if the SIP packet is an SIP REGISTER, steps of (S211) extracting a terminal model name and a VoLTE version from a user-agent field of the SIP packet, and (S230 and S240) determining whether or not encryption is applied, and (S250) updating the reputation information by terminal of the terminal reputation DB 410 are carried out. The VoLTE version means version information of TTA-VoLTE.

On the other hand, in the step S210, if the SIP packet is not the SIP REGISTER, a step S220 of determining whether or not the SIP packet is an authentication response according to a 401 unauthenticated code.

In this instance, in the step S220, if the SIP packet is the authentication response according to the 401 unauthenticated code, steps of (S230 and S240) determining whether or not encryption is applied and (S250) updating the reputation information by terminal of the terminal reputation DB 410 are carried out.

In the step S230, the control unit 420 determines whether or not there exists security headers in all of the REQEST and RESPONSE of the packet. In this instance, if there is no security header in the REQEST and RESPONSE of the packet, it is determined that encryption is not applied, and then, the reputation information by terminal of the terminal reputation DB 410 is updated (S250).

On the other hand, if the security header exists in all of the REQEST and RESPONSE of the packet, it is checked whether or not the security header (Ealg) used for encryption is null (S240). In this instance, if the security header is null, it is determined that encryption is not applied. If the security header is not null, it is checked whether or not the security header (Ealg) of the SIP packet transmitted from the client terminal 100 and the security header (Ealg) of the SIP packet transmitted to the SIP server 200 are the same.

In this instance, if the two security headers (Ealg) are the same, it is determined that encryption is applied, and if the two security headers (Ealg) are different from each other, it is determined that encryption is not applied, and then, the reputation information by terminal of the terminal reputation DB 410 is updated (S250).

The reputation information by terminal of the terminal reputation DB 410 is updated (S250).

The reputation information by terminal of the terminal reputation DB 410 updated in the step S250 is shown in the following Table 1, but is not limited thereto, and additional items may be added.

TABLE 1

| | | | Number of |
|---|---|---|---|
| User | | IPSEC-applied | reputation |
| information | VoLTE | reputation | changes |
| A | TTA-VoLTE 3.0 | Applied | 0 |
| B | TTA-VoLTE 2.0 | Not applied | 1 |
| C | TTA-VoLTE 3.0 | Not applied | 4 |

On the other hand, in the step S220, if the SIP packet is not the authentication response, the SIP packet inspection is terminated.

In addition, the control unit 420 of the intrusion prevention system 400 for 5G mobile communication according to the embodiment of the present invention can block the connection of the client terminal if the reputation of the client terminal stored in the terminal reputation DB 410 is lower than a predetermined reference value.

Therefore, the SIP noncoding detection system according to the present invention can manage reputation of a client terminal according to whether or not the client terminal sends an encoded SIP message through a 5G non-standalone/Standalone (5G NSA/SA), thereby preventing an SIP spoofing attack.

The above description is only exemplary, and it will be understood by those skilled in the art that the disclosure may be embodied in other concrete forms without changing the technological scope and essential features. Therefore, the above-described embodiments should be considered only as examples in all aspects and not for purposes of limitation.

What is claimed is:

1. A method for detecting session initiation protocol (SIP) noncoding through a session initiation protocol (SIP) noncoding detection system comprising the steps of:
requesting a call connection with a receiving terminal to a session initiation protocol (SIP) server using a session initiation protocol (SIP) in a SIP client terminal; and
receiving an SIP packet from the SIP client terminal and the SIP server and generating reputation by terminal in an intrusion prevention system for 5G mobile communication.

2. The method for detecting SIP noncoding according to claim 1, wherein the step of receiving the SIP packet from the SIP client terminal and the SIP server and generating reputation by terminal in the intrusion prevention system for 5G mobile communication comprises the steps of:
determining whether or not the SIP packet is an SIP REGISTER by a control unit;
determining whether or not the SIP packet is an authentication response according to a 401 unauthenticated code if the SIP packet is not the SIP REGISTER; and
determining whether or not encryption of the SIP packet is applied if the SIP packet is an authentication response according to a 401 unauthenticated code, and updating reputation information by terminal of a terminal reputation DB.

3. The method for detecting SIP noncoding according to claim 2, wherein in the step of determining whether or not the SIP packet is an SIP REGISTER, if the SIP packet is an SIP REGISTER, the control unit extracts a terminal model name and a VoLTE version from a user-agent field of the SIP packet, determines whether or not encryption is applied, and updates the reputation information by terminal of the terminal reputation DB.

4. The method for detecting SIP noncoding according to claim 2, wherein in the step of determining whether or not the SIP packet is an authentication response according to a 401 unauthenticated code, if the SIP packet is not an authentication response, the control unit terminates an SIP packet inspection.

5. A system for detecting session initiation protocol (SIP) noncoding comprising:
a session initiation protocol (SIP) client terminal for requesting a call connection with a receiving terminal to a session initiation protocol (SIP) server using a session initiation protocol (SIP); and
an intrusion prevention system for 5G mobile communication which receives a session initiation protocol (SIP) packet from the SIP client terminal and the SIP server and manages reputation by terminal.

6. The system for detecting SIP noncoding according to claim 5, wherein the intrusion prevention system for 5G mobile communication comprises:
a terminal reputation DB storing reputation information by terminal; and
a control unit receiving a session initiation protocol (SIP) packet from the SIP server and storing the reputation information by terminal to the terminal reputation DB.

7. The system for detecting SIP noncoding according to claim 6, wherein the control unit carries out the steps of:
determining whether or not the SIP packet is an SIP REGISTER;
determining whether or not the SIP packet is an authentication response according to a 401 unauthenticated code if the SIP packet is not the SIP REGISTER; and
determining whether or not encryption of the SIP packet is applied if the SIP packet is an authentication response according to a 401 unauthenticated code, and updating reputation information by terminal of a terminal reputation DB.

8. The system for detecting SIP noncoding according to claim 7, wherein in the step of determining whether or not the SIP packet is an SIP REGISTER, if the SIP packet is an SIP REGISTER, the control unit extracts a terminal model name and a VoLTE version from a user-agent field of the SIP packet, determines whether or not encryption is applied, and updates the reputation information by terminal of the terminal reputation DB.

9. The system for detecting SIP noncoding according to claim 7, wherein in the step of determining whether or not the SIP packet is an authentication response according to a 401 unauthenticated code, if the SIP packet is not an authentication response, the control unit terminates an SIP packet inspection.
